(19) United States
(12) Patent Application Publication
(10) Pub. No.: US 2011/0167229 A1
(43) Pub. Date: Jul. 7, 2011

(54) BALANCED DATA-INTENSIVE COMPUTING

(75) Inventors: Sandor Szalay, Baltimore, MD (US); Alainna White, Baltimore, MD (US); Jan Vandenberg, Baltimore, MD (US); Hao Howie Huang, McLean, VA (US); Andreas Terzis, Baltimore, MD (US); Gordon Bell, San Francisco, CA (US)

(73) Assignee: The Johns Hopkins University, Baltimore, MD (US)

(21) Appl. No.: 12/970,533

(22) Filed: Dec. 16, 2010

Related U.S. Application Data
(60) Provisional application No. 61/287,005, filed on Dec. 16, 2009.

(51) Int. Cl. G06F 12/00

(52) U.S. Cl. 711/154; 711/E12.001

(57) ABSTRACT

A computing device including a processor operable to process data at a processing speed and a storage device in communication with the processor operable to retrieve stored data at a data transfer rate, where the data transfer rate matches the processing speed.

### CROSS-REFERENCE TO RELATED APPLICATION

This application claims priority to U.S. Provisional Application No. 61/287,005 filed Dec. 16, 2009, the entire contents of which are hereby incorporated by reference.

### BACKGROUND

1. Field of Invention

The current invention relates to computing devices or computing systems, and more particularly to balanced data-intensive computing.

2. Discussion of Related Art

The contents of all references, including articles, published patent applications and patents referred to anywhere in this specification are hereby incorporated by reference.

Scientific data sets are approaching petabytes today. At the same time, enterprise data warehouses routinely store and process even larger amounts of data. Most of the analyses performed over these datasets (e.g., data mining, regressions, calculating aggregates and statistics, etc.) need to look at large fractions of the stored data. Thereby, sequential throughput is becoming the most relevant metric to measure the performance of data-intensive systems. Given that the relevant data sets do not fit in main memory, they have to be stored and retrieved from disks. For this reason, understanding the scaling behavior of hard disks is critical for predicting the performance of existing data-intensive systems as data sets continue to increase.

Over the last decade the rotation speed of large disks used in disk arrays has only changed by a factor of three, from 5,400 revolutions per minute (RPM) to 15,000 RPM, while disk sizes have increased by a factor of 1,000. Likewise, seek times have improved only modestly over the same time period because they are limited by mechanical strains on the disk's heads. As a result, random access times have only improved slightly. Moreover, the sequential I/O rate has grown with the square root of disk capacity since it depends on the disk platter density.

As a concrete example of the trends described above, the sequential Input/Output (I/O) throughput of commodity Serial Advanced Technology Attachment (SATA) drives is 60-80 MegaBytes (MB)/sec today, compared to 20 MB/sec ten years ago. However, considering the vast increase in disk capacity this modest increase in throughput has effectively turned the hard disk into a serial device: reading a terabyte disk at this rate requires 4.5 hours. Therefore, the only way to increase aggregate I/O throughput is to use more smaller disks and read from them in parallel. In fact, modern data warehouse systems, such as the GrayWulf cluster described next, aggressively use this approach to improve application performance.

The GrayWulf system (A. Szalay and G. Bell et al. GrayWulf, Scalable Clustered Architecture for Data Intensive Computing. In Proceedings of HICSS-42 Conference, 2009) represents a state-of-the-art architecture for data-intensive applications, having won the Storage Challenge at SuperComputing 2008. Focusing primarily on sequential I/O performance, each GrayWulf server consists of 30 locally attached 750 GigaByte (GB) SATA drives, connected to two Dell PERC/6 controllers in a Dell 2950 server with 24 GB of memory and two four-core Intel Xeon processors clocked at 2.66 GHz. The raw read performance of this system is 1.5 GB/s, translating to 15,000 seconds (4.2 hours) to read all the disks. Such a building block costs approximately $12,000 in 2009 prices and offers a total storage capacity of 22.5 TB. Its power consumption is 1,150 W. The GrayWulf consists of 50 such servers, and this parallelism linearly increases the aggregate bandwidth to 75 GB/sec, the total amount of storage to more than 1.1 PetaBytes (PB) and the power consumption to 56 kilo Watts (kW). However, the time to read all the disks remains 4.2 hours, independent of the number of servers.

Doubling the storage capacity of the GrayWulf cluster, while maintaining its per-node current throughput, would require using twice as many servers, thereby doubling its power consumption. Alternatively, one could divide the same amount of data over twice as many disks (and servers) to double the system's throughput at the cost of doubling its power consumption. At this rate, the cost of building and operating these ever expanding facilities is becoming a major roadblock not only for universities but even for large corporations (A. Szalay and G. Bell et al. GrayWulf, Scalable Clustered Architecture for Data Intensive Computing. In Proceedings of HICSS-42 Conference, 2009). Thus tackling the next generation of data-intensive computations in a power-efficient fashion requires a radical departure from existing approaches.

There is thus a need for improved data-intensive computing devices or computing systems.

### SUMMARY

A computing device according to an embodiment of the current invention has a processor operable to process data at a processing speed and a storage device in communication with the processor operable to retrieve stored data at a data transfer rate, where the data transfer rate substantially matches the processing speed.

A system according to an embodiment of the current invention has a first computing device. The first computing device has a processor operable to process data at a processing speed and a storage device in communication with the processor operable to retrieve stored data at a data transfer rate, where the data transfer rate substantially matches the processing speed. The system further has a second computing device in communication with the first computing device. The second computing device has a second processor operable to process data at a second processing speed and a second storage device in communication with the second processor operable to retrieve stored data at a second data transfer rate, where the second data transfer rate substantially matches the second processing speed.

### BRIEF DESCRIPTION OF THE DRAWINGS

The invention may be better understood by reading the following detailed description with reference to the accompanying figures, in which:

FIG. 1 is a block diagram of a computing device according to an embodiment of the current invention;

FIG. 2 is a block diagram of a computing device having a processor with two processing units, and a storage device having two storage units according to an embodiment of the current invention;

FIG. 3 is a block diagram of a computing device having two pairs of processors and storage units according to an embodiment of the current invention;

FIG. 4 is a block diagram of a computing device having additional components according to an embodiment of the current invention;

FIG. 5 is a block diagram of a system of computing devices according to an embodiment of the current invention; and

FIG. 6 is a graph of read and write performance over block size in an embodiment of the current invention.

### DETAILED DESCRIPTION

In describing embodiments of the present invention illustrated in the drawings, specific terminology is employed for the sake of clarity. However, the invention is not intended to be limited to the specific terminology so selected. It is to be understood that each specific element includes all technical equivalents which operate in a similar manner to accomplish a similar purpose.

Data sets generated by scientific instruments and business transactions continue to double per year, creating a dire need for a scalable data-intensive computing solution (G. Bell, T. Hey, and A. Szalay. Beyond the data deluge. Science, 323(5919):1297-1298, 2009). At the same time, the energy consumption of existing data warehouses increases linearly with their size, leading to prohibitive costs for building and operating ever-growing data processing facilities (J. Hamilton. Cooperative expendable micro-slice servers (cems). In Proceedings of CIDR 09, 2009). One problem is the fact that existing systems used for data-intensive applications are unbalanced, in that disk throughput cannot match a Central Processing Unit's (CPU) processing speeds and application requirements.

A system's throughput is limited by the throughput of its slowest component. Thereby for a given per-disk throughput D, performance increases linearly with the total number of disks d, until the aggregate disk throughput saturates the CPU capacity for a given application workload. In practical terms, increasing the total number of disks requires increasing the number of servers s, as the aggregate throughput of the locally-attached disk enclosure is configured to saturate the server's Input/Output (I/O) bandwidth. At the same time, power consumption increases linearly with the number of servers. Finally, having CPUs that can process data faster than the I/O subsystem can deliver is counterproductive: it does not increase the systems' throughput, while it increases its power consumption.

Gene Amdahl codified these relations in three laws that describe the characteristics of well-balanced computer systems (G. Amdahl. Computer architecture and Amdahl's law. IEEE Solid State Circuits Society News, 12(3):4-9, 2007). Specifically, these laws state that a balanced computer system:
(1) needs one bit of sequential I/O per sec per instruction per sec—the Amdahl number;
(2) has memory with a MegaByte/Million Instructions Per Second (MB/MIPS) ratio close to 1—the Amdahl memory ratio;
(3) performs one I/O operation per 50,000 instructions—the Amdahl Input/Output Operations Per Second (IOPS) ratio.

For example, the GrayWulf server described in the previous section has an Amdahl number of 0.56 and a memory ratio of 1.12 MB/MIPS. Finally, the third Amdahl law requires 426 kilo Input/Output operations per second (KIOPS) to match the CPU speed, while the hard disks can only deliver about 6 KIOPS, a ratio of 0.014.

One can extend the Amdahl number from hardware platforms to computational problems: take the data set size in bits and divide with the number of cycles required to process it. While supercomputer simulations have Amdahl numbers of 10⁻⁵, pipeline processing of observational astronomy data requires 10⁻², while the Amdahl numbers for user analyses of derived catalogs and database queries approach unity. Thus, aiming for systems with high Amdahl numbers at a given performance level is likely to result in balanced and thus energy-efficient systems.

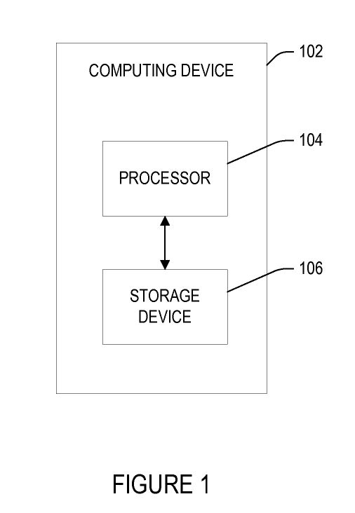

FIG. 1 is a block diagram of a computing device 102 according to an embodiment of the current invention. The computing device 102 includes a processor 104 operable to process data at a processing speed. The processor 104 may be a CPU of the computing device 102 and carries out instructions on data according to one or more programs. The processing speed may be the peak processing speed of the processor 104. Also, the processing speed may be the rate at which the processor 104 processes data. The processing speed is dependent on both the clock rate of the processor 104 and the instructions per clock (IPC) of the processor 104, which together are the factors for the instructions per second (IPS) that the processor 104 can perform. The amount of data the processor 104 processes per instruction can be combined with the IPS of the processor 104 to determine the processing speed of the processor 104.

The computing device 102 further includes a storage device 106 in communication with the processor 104 operable to retrieve stored data at a data transfer rate. The storage device 106 is a data storage device from which data can be retrieved. Example storage devices 106 include a secondary storage device, a device not directly accessible by the processor, and/or a mass storage device, a device that stores large amounts of data in a persisting and machine-readable fashion. Further examples of storage devices 106 include, but are not limited to, a hard disk drive, a solid state hard drive, a flash memory drive, a magnetic tape drive, or an optical drive, etc. The data transfer rate of the storage device 106 may be the amount of data in a certain period of time that the storage device 106 is able to transfer. Example data transfer rates may be throughput, maximum theoretical throughput, peak measured throughput, maximum sustained throughput, etc.

Further, in the computing device 102 the data transfer rate substantially matches the processing speed. The data transfer rate of the storage device 106 and the processing speed of the processor 104 are balanced. Ideally, the rate at which the storage device 106 is able to provide data for the processor 104 is similar to the rate at which the processor 104 is able to process data. However, the ratio of the data transfer rate and the processing speed may be between 0.6 to 1.7. Additionally, ratios outside of the range of 0.6 to 1.7 may also be beneficial for data processing and considered as substantially matching.

Moreover, in some cases the rate at which the processor 104 is able to process data may not directly correspond to the IPS of a processor 104 because the processing speed may account for processing by the processor 104 which is unrelated to the processing of the data. Examples of unrelated processing include background processes, operating system processes, system monitoring, logging, scheduling, user notification, rendering, etc.

As a conventional system's throughput is typically limited by the data transfer rate of the system's storage device because the processing speed of the system's processor is faster than the data transfer rate of the system, the processor 104 of the computing device 102 may be a low power processor with a lower processing speed. Examples of low power processors include processors which are deliberately underclocked to use less power at the expense of performance, for example, but not limited to, the Intel Atom, Intel Pentium M, AMD Athlon Neo, AMD Geode, VIA Nano, NVIDIA Ion, etc. Additionally, the storage device 106 of the computing device 102 may be a storage device with a high data transfer rate. For example, the storage device 106 may be, a solid-state drive, an enterprise flash drive (EFD), a high performance hard drive disk, etc.

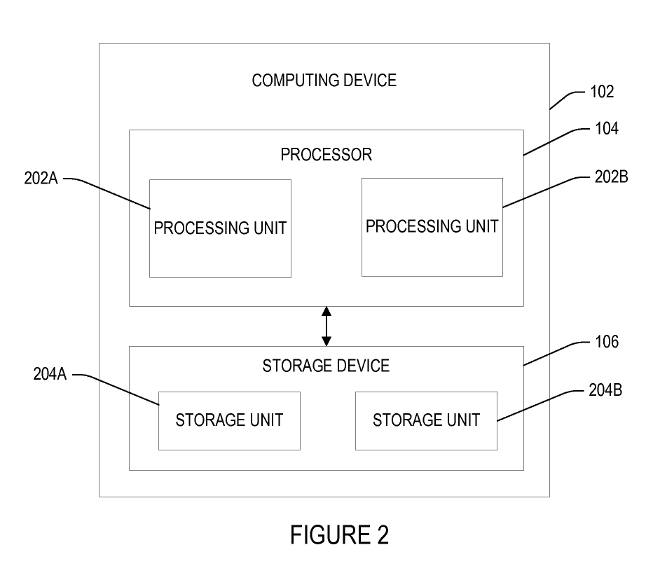

FIG. 2 is a block diagram of a computing device having a processor 104 with two processing units 202A, 202B and a storage device 106 having two storage units 204A, 204B according to an embodiment of the current invention. The processor 104 may include a multi-core processor with two or more processing units 202A, 202B. Each processing unit 202A, 202B may correspond with a core of the multi-core processor. Further, the storage units 204A, 204B may be individual storage devices together represented by a logical unit. For example, the storage device 106 may be a redundant array of independent disks (RAID) which the computing device 102 may view as a single storage device. Use of a RAID array in mirroring or striping may increase the data transfer rate at nearly a multiple of the number of storage device 202A, 202B used. Other methods of increasing data transfer rate by adding additional storage devices 106 may also be used. For example, the storage device 106 may have a SSD as a first storage unit and a hard disk drive as a second storage unit.

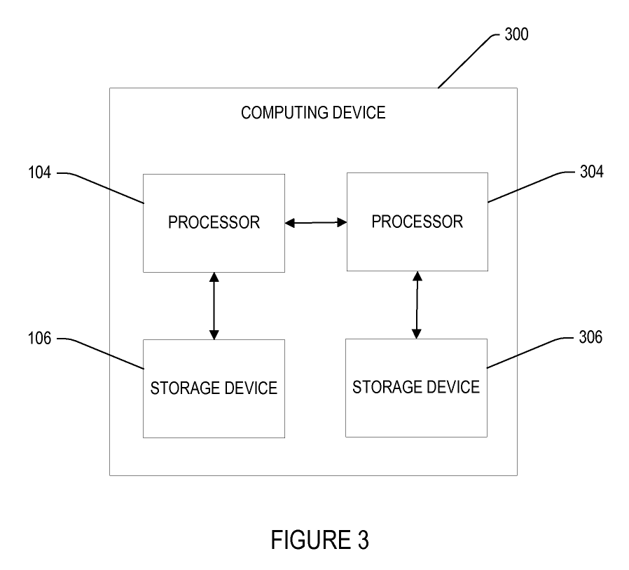

FIG. 3 is a block diagram of a computing device 300 having two pairs of processors 104, 304 and storage units 106, 306 according to an embodiment of the current invention. The computing device 300 includes a plurality of processors 104, 304 adapted to process the data. The computing device 300 includes a first processor 104 in communication with a first storage device 106, and further includes a second processor 304 in communication with a second storage device 306 and in communication with the first processor 104. Each processor 104, 304 may further include one or more processing units and each storage device 106, 306 may further include one or more storage units.

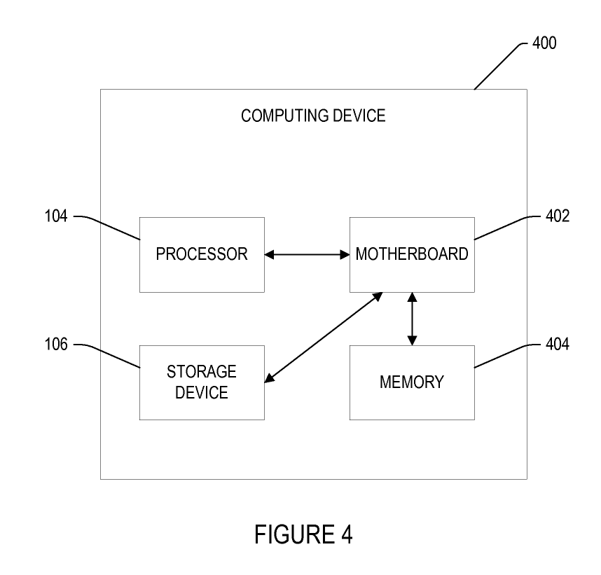

FIG. 4 is a block diagram of a computing device 400 having additional components according to an embodiment of the current invention. The computing device 400 further includes a motherboard 402 in communication with the processor 104 and the storage device 106. The processor 104 and storage device 106 do not directly communicate with one another, but instead communicate with each other through the motherboard 402. The computing device 400 further includes memory 404 in communication with the motherboard 402. The memory 404 may also store data utilized by the processor 104. However, the memory 404 may be differentiated from the storage device 106 in that the memory 404 may be directly accessible by the processor 104. For example, the memory 404 may be a primary storage device such as random access memory (RAM). While RAM is volatile memory, memory 404 may also be non-volatile memory. In other embodiments, the memory 404 may also be integrated in the processor 104, for example, as a processor register, or a processor cache, etc.

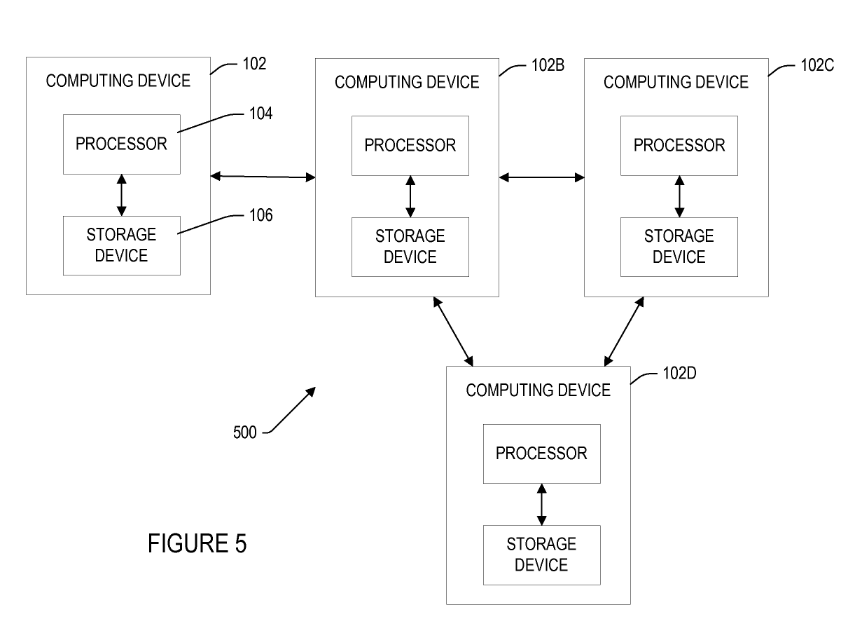

FIG. 5 is a block diagram 500 of a system of computing devices 102, 102B, 102C, 102D. The system includes a plurality of computing devices 102, 102B, 102C, 102D. Each computing device 102, 102B, 102C, 102D may be based on an embodiment of the computing device 102 previously described. A first computing device 102 is in communication with a second computing device 102B. The first computing device 102 and second computing device 102B may define a distributed system where the devices are able to interact with each other to achieve a common goal. The system may also be a grid computing system or a cluster computing system.

The system further includes a third computing device 102C in communication with the second computing device 102B. The computing devices of the system do not need to be directly in communication with one another. As shown in FIG. 5, the third computing device 102C is not directly in communication with the first computing device 102. Additionally, in an embodiment the third computing device 102C is not directly in communication with the first computing device 102. Further, the system includes a fourth computing device 102D in communication with the second computing device 102B and the third computing device 102C. As seen in FIG. 5, the second 102B, third 102C, and fourth computing device 102D are all in communication with one another. However, the system may also include a computing device which is only in communication with a subset of the computing devices of the system, for example, the first computing device 102 in FIG. 5.

### Examples

Disk throughput currently does not match CPU processing speeds and application requirements. This performance and energy-efficiency conundrum may be resolved by leveraging two recent technology innovations: Solid State Disks (SSDs) that combine high I/O rates with low power consumption and energy-efficient processors (e.g., Intel's Atom family of CPUs and NVIDIA's Ion Graphics Processing Unit (GPU) chipsets) originally developed for use in mobile computers. It is possible to use these components to build balanced so-called Amdahl blades offering very high performance per Watt. Specifically, Amdahl blade prototypes built using commercial off-the-shelf (COTS) components can offer five times the throughput of a current state-of-the-art data intensive computing cluster, while keeping the total cost of ownership constant. Alternatively, it is possible to keep the power consumption constant while increasing the sequential I/O throughput by more than ten times.

### Solid State Disks

Rather than increasing the number of disks d, the per-disk throughput D can be increased, thereby decreasing the total number of servers s, ideally while keeping per-disk power consumption low. In fact, Solid State Disks (SSDs) that use similar flash memory as the one used in memory cards, provide both desired features. Current SSDs offer sequential I/O throughput of 90-250 MB/s and 10-30 KIOPS (Intel Corporation. Intel x25-e SATA solid state drive. Available from: http://download.intel.com/design/flash/nand/extreme/extreme-sata-ssd-datasheet.pdf) (OCZ Technology. OCZ Flash Media: OCZ Vertex Series SATAII 2.5 SSD. Available from: http://www.ocztechnology.com/products/flash_drives/ocz_vertex_series_sata_ii_{—}2_{—}5-ssd). The total time to read a 250 GB disk at these rates is 1,000 seconds, a factor of 15 improvement over the GrayWulf. Furthermore, these drives require 0.2 W while idle and 2 W at full speed (P. Schmid and A. Roos. Flash SSD Update: More Results, Answers. Available from: http://www.tomshardware.com/reviews/ssd-harddrive, 1968.html, 2008). SSDs are available at retail prices of $330 for a 120 GB model, and $700-$900 for 250 GB. Prices however are decreasing quickly.

Projecting a few months into the future, the per disk sequential access speed will probably not grow considerably, since the current limiting factor is the 3 Gbit/s SATA bandwidth. Further ahead, the emergence of 6 Gbit/s SATA controllers on inexpensive motherboards and SSDs will provide a way to higher sequential speeds at an affordable price point. This limitation may be exceeded by putting the flash memory directly onto the motherboard, eliminating the disk controller. The market will probably force motherboard and disk manufacturers to stay with the standard SATA interfaces for a while to ensure large production quantities and economies of scale. Also, boutique solutions with a direct access to flash, such as the FusionIO products (Fusion-IO. ioDrive. Available from: http://www.fusionio.com/PDFs/Fusion_Specsheet.pdf) are unlikely to become a commodity.

### Scale-Up: SSDs on High-End Servers:

One way to deploy SSDs in data-intensive computations is through an approach termed scale-up: use high-end servers and connect multiple SSDs to each server, the same way the GrayWulf nodes are built. While this appears to be the most intuitive approach, the examples show that current high-end disk controllers saturate at 740 MB/sec. In turn, this limit means that each set of three high speed SSDs will require a separate controller. Soon enough, servers will run out of PCI slots as well as PCI and network throughput.

### Scale-Down: Low Power Systems:

Instead of scaling up, data can be split into multiple partitions across multiple servers (P. Furtado. Algorithms for Efficient Processing of Complex Queries in Node Partitioned Data Warehouses. Database Engineering and Applications Symposium, 7-9 July, pages 117-122, 2004) to its logical extreme: use a separate CPU and host for each disk, building the cyber-brick originally advocated by Jim Gray (T. Barclay, W. Chong, and J. Gray. Terraserver bricks: A high availability cluster alternative. Technical Report MSR-TR-2004-107, Microsoft Research, 2004). In fact, if an SSD is paired with one of the recent energy-efficient CPUs used in laptops and netbooks (e.g., Intel's Atom N270 (Intel. Intel Atom Processor. Available from: http://www.intel.com/technology/atom/, 2009) clocked at 1.6 GHz), an Amdahl number is arrived at close to one. Moreover, the IOPS Amdahl ratio is very close to ideal: a 1.6 GHz CPU would be perfectly balanced with 32,000 IOPS, close to what current SSDs can offer. Given its balanced performance across all the dimensions mentioned in Amdahl's laws, such a server is termed an Amdahl blade. Adding a dual-core CPU and a second SSD to such a blade increases packing density at a modest increase in power since the SSDs consume negligible power compared to the motherboard.

### Phase 1: Evaluation of Different Platforms

TABLE 1
Low Power motherboards considered for the Amdahl Blades

| System | Model | CPU | Chipset |
|---|---|---|---|
| ASUS | EeeBox | N270 | 945GSE |
| Intel | D945GCLF2 | N330 | 945GC |
| Zotac | ION | N330 | ION |
| AxiomTek | Pico820 | Z530 | US15W |
| ALIX | 3C2 | LX800 | AMD |

Amdahl blades can be built using COTS components to evaluate their potential in data-intensive applications. Table 1 compares the characteristics of the systems used in the Phase 1 example. All Amdahl blades in the example use variants of the Intel Atom processor clocked at 1.6 GHz. The N330 CPU has two cores while the rest have a single core. These systems are compared to the GrayWulf system (A. Szalay and G. Bell et al. GrayWulf, Scalable Clustered Architecture for Data Intensive Computing. In Proceedings of HICSS-42 Conference, 2009) and the ALIX 3C2 node that uses the LX800 500 MHz Geode CPU from AMD and a Compact Flash (CF) card for storage. The ALIX node is included in the comparison because it is used by the FAWN project that recently proposed an alternative power-efficient cluster architecture for data-intensive computing (V. Vasudevan, J. Franklin, D. Andersen, A. Phanishayee, L. Tan, M. Kaminsky, and J. Moraru. FAWNdamentally Power Efficient Clusters. In Proceedings of HotOS, 2009). The blades' performance is measured by installing Windows 7 Release Candidate and running the SQLIO utility that simulates realistic sequential and random disk access patterns (D. Cherry. Performance Tuning with SQLIO. Available from: http://sqlserverpedia.com/wiki/SAN_Performance_Tuning_with_SQLIO, 2008). Block sizes from 8 KB to 1 MB at 4× increments are run. Furthermore, each test using 1, 2, and 32 threads are run. Each test runs for sixty seconds using an 8 GB dataset. Previously reported measurements for the ALIX system assuming an 8 GB CF card are used, while the GrayWulf was previously evaluated using a similar methodology (A. Szalay and G. Bell et al. GrayWulf, Scalable Clustered Architecture for Data Intensive Computing. In Proceedings of HICSS-42 Conference, 2009). Power consumption under peak load is measured using both a Kill-A-Watt power meter and directly at the DC input of the motherboards, whenever possible.

TABLE 2
Performance, power and cost characteristics of the systems considered.

| | CPU | SeqIO | RandIO | Disk | Power | Cost | Relative | Amdahl Numbers | | |
|---|---|---|---|---|---|---|---|---|---|---|
| | [GHz] | [GB/s] | [kIOPS] | [TB] | [W] | [$] | power | SeqIO | Mem | RndIO |
| GrayWulf | 21.3 | 1.500 | 6.0 | 22.50 | 1150 | 19,253 | 1.0000 | 0.56 | 1.13 | 0.014 |
| ASUS | 1.6 | 0.124 | 4.6 | 0.25 | 19 | 820 | 0.0165 | 0.62 | 1.25 | 0.144 |
| Intel | 3.2 | 0.500 | 10.0 | 0.50 | 28 | 1,177 | 0.0243 | 1.25 | 0.63 | 0.156 |
| Zotac | 3.2 | 0.500 | 10.4 | 0.50 | 30 | 1,189 | 0.0261 | 1.25 | 1.25 | 0.163 |
| Pico820 | 1.6 | 0.120 | 4.0 | 0.25 | 15 | 995 | 0.0130 | 0.60 | 1.25 | 0.125 |
| ALIX | 0.5 | 0.025 | N/A | 0.008 | 4 | 225 | 0.0035 | 0.40 | 1.00 | N/A |
| hybrid | 3.2 | 0.330 | 6.0 | 2.25 | 45 | 1,084 | 0.0391 | 0.83 | 0.16 | 0.094 |

### Throughput and Power Consumption

The CPU column in Table 2 corresponds to the individual CPU speed multiplied by the number of cores. While this metric overlooks important performance aspects, such as differences in CPU micro-architectures and available level of parallelism, it is used as a first approximation of processing throughput for calculating the relative Amdahl numbers. One SSD per core is used and therefore the Intel and Zotac motherboards that utilize the same two-core Intel Atom N330 CPU have two drives. All SSD tests use identical OCZ 120 GB Vertex drives (OCZ Technology. OCZ Flash Media: OCZ Vertex Series SATAII 2.5 SSD. Available from: http://www.ocztechnology.com/products/flash_drives/ocz_vertex_series_sata_ii_{—}2_{—}5-ssd). Also included is a hybrid node, which consists of a Zotac board with a single OCZ drive, and two Samsung Spinpoint F1 1 TB conventional hard drives, but with a 7.5 W power drain.

The tests show that the Zotac and Intel boards offer the best sequential read performance, 250 MB/s per SSD or an aggregate of 500 MB/s using two threads. This value was obtained for block sizes of 256 KB, due to the Atom's 512 KB L1 cache. The aggregate sequential read rate decreases to 450 MB/s with 32 threads on the dual-core motherboards. On the other hand, the maximum sequential I/O for single-core motherboards is only 124 MB/s. Furthermore, the maximum per disk write performance levels off at 180 MB/s for random I/O and 195 MB/s for sequential I/O. Finally, the dual-core boards deliver 10.4 KIOPS compared to 4.4 KIOPS for the single-core boards under a workload of random read patterns.

To calculate the total cost of ownership the approximate cost of purchasing and operating each system is estimated over a period of three years. The acquisition cost using June 2009 retail prices for motherboards and the actual prices used to purchase the GrayWulf (GW) system in July 2008 are calculated. For the SSD-based systems the cost and disk size columns in Table 2 represent projections for a 250 GB drive with the same performance and a projected cost of $400 at the end of 2009. This projection is inline with historic SSD price trends. Power consumption varies between 15 W-30 W depending on the chipset used (945GSE, USW15, ION) and generally agrees with the values reported in the motherboards' specifications. A difference is the AxiomTek board, which tested at 15 W rather than the published 5 W figure. The current university rate for electric power at Johns Hopkins University is $0.15/kWh. The total cost of power should also include the cost for cooling water and air conditioning, thus the electricity cost is multiplied by 1.6 to account for these additional factors (J. Hamilton. Cooperative expendable micro-slice servers (cems). In Proceedings of CIDR 09, 2009). The Cost column in Table 2 reflects the corresponding cumulative costs. Lastly, the different Amdahl numbers and ratios for the various node types are presented. Compared to the GrayWulf and ALIX, it is clear the Atom systems, especially with dual cores, are better balanced across all three dimensions.

TABLE 3
The scaling properties of the proposed systems along the different dimensions

| | | | | | | | |
|---|---|---|---|---|---|---|---|
| CPU | Seq IO | RandIO | Disk | Power | Cost | Relative | Node |
| [GHz] | [GB/s] | [kIOPS] | [TB] | [W] | [$] | power | count |

constant price

| | | | | | | | | |
|---|---|---|---|---|---|---|---|---|
| GrayWulf | 21 | 1.5 | 6 | 22.5 | 1150 | 19253 | 1.0000 | 1.0 |
| ASUS | 38 | 2.9 | 108 | 5.9 | 446 | 19253 | 0.3880 | 23.5 |
| Intel | 52 | 8.2 | 164 | 8.2 | 458 | 19253 | 0.3984 | 16.4 |
| Zotac | 52 | 8.1 | 168 | 8.1 | 486 | 19253 | 0.4223 | 16.2 |
| Pico820 | 31 | 2.3 | 77 | 4.8 | 290 | 19253 | 0.2525 | 19.4 |
| Alix 3C2 | 43 | 2.1 | N/A | 0.7 | 342 | 19253 | 0.2973 | 85.5 |
| hybrid | 57 | 5.9 | 107 | 40.0 | 799 | 19253 | 0.6951 | 17.8 |

constant sequential IO

| | | | | | | | | |
|---|---|---|---|---|---|---|---|---|
| GrayWulf | 21 | 1.5 | 6 | 22.5 | 1150 | 19253 | 1.0000 | 1.0 |
| ASUS | 19 | 1.5 | 56 | 3.0 | 230 | 9917 | 0.1999 | 12.1 |
| Intel | 10 | 1.5 | 30 | 1.5 | 84 | 3530 | 0.0730 | 3.0 |
| Zotac | 10 | 1.5 | 31 | 1.5 | 90 | 3568 | 0.0783 | 3.0 |
| Pico820 | 20 | 1.5 | 50 | 3.1 | 188 | 12433 | 0.1630 | 12.5 |
| Alix 3C2 | 30 | 1.5 | N/A | 0.5 | 240 | 13514 | 0.2087 | 60.0 |
| hybrid | 15 | 1.5 | 27 | 10.2 | 205 | 4926 | 0.1779 | 4.5 |

constant power

| | | | | | | | | |
|---|---|---|---|---|---|---|---|---|
| GrayWulf | 21 | 1.5 | 6 | 22.5 | 1150 | 19253 | 1.0000 | 1.0 |
| ASUS | 97 | 7.5 | 278 | 15.1 | 1150 | 49622 | 1.0000 | 60.5 |
| Intel | 131 | 20.5 | 411 | 20.5 | 1150 | 48325 | 1.0000 | 41.1 |
| Zotac | 123 | 19.2 | 399 | 19.2 | 1150 | 45587 | 1.0000 | 38.3 |
| Pico820 | 123 | 9.2 | 307 | 19.2 | 1150 | 76253 | 1.0000 | 76.7 |
| Alix 3C2 | 144 | 7.2 | N/A | 2.3 | 1150 | 64753 | 1.0000 | 287.5 |
| hybrid | 82 | 8.4 | 153 | 57.5 | 1150 | 27698 | 1.0000 | 25.6 |

constant disk size

| | | | | | | | | |
|---|---|---|---|---|---|---|---|---|
| GrayWulf | 21 | 1.5 | 6 | 22.5 | 1150 | 19253 | 1.0000 | 1.0 |
| ASUS | 144 | 11.2 | 414 | 22.5 | 1710 | 73785 | 1.4870 | 90.0 |
| Intel | 144 | 22.5 | 450 | 22.5 | 1260 | 52947 | 1.0957 | 45.0 |
| Zotac | 144 | 22.5 | 468 | 22.5 | 1350 | 53515 | 1.1739 | 45.0 |
| Pico820 | 144 | 10.8 | 360 | 22.5 | 1350 | 89515 | 1.1739 | 90.0 |
| Alix 3C2 | 1406 | 70.3 | N/A | 22.5 | 11250 | 633456 | 9.7826 | 2812.5 |
| hybrid | 32 | 3.3 | 60 | 22.5 | 450 | 10838 | 0.3913 | 10.0 |

### Scaling Properties

Table 3 illustrates what happens when the other systems are scaled to match the GrayWulfs sequential I/O, power consumption, and disk space. The Nodes column presents the number of nodes necessary to match the GW's performance in the selected dimension, while the remaining columns provide the aggregate performance across all these nodes. One notes that a cluster of only three Intel or Zotac nodes will match the sequential I/O of the GrayWulf and deliver five times faster IOPS, while consuming 90 W, compared to 1150 W for the GW. A shortcoming of this alternative is that the total storage capacity is 15 times smaller (i.e., 1.5 TB vs. 22.5 TB). At the same time, the power for a single GrayWulf node can support 41 Intel and 38 Zotac nodes, respectively and offer more than ten times higher sequential I/O throughput.

Table 3 also shows that one needs to strike a balance between low power consumption and high performance. For example, while the sequential I/O performance of the ALIX system matches that of the GrayWulf at a constant price, it falls behind that of the Amdahl blades. Furthermore, one needs 60 ALIX boards to match the sequential rate of a GW node which consume approximately three times more power than the equivalent Intel system (240 W vs. 84 W).

### 2. Example Hardware Configuration

Based on the results from the Phase 1 example, the following two-tier system may be built:
A 50 node cluster consisting of Zotac ION motherboards with dual core N330 Atom CPUs and 4 GB of memory,
The cluster will have a combination of pure SSD nodes and hybrid nodes with both SSD and low-power hard disks.
The average Amdahl number for the system will be unity. (1.25 for the SSD nodes, 0.83 for the hybrid).
Each 8 nodes will be connected to a Gbit Ethernet switch and two hybrid head nodes will serve as aggregators with an additional switch.

The Zotac motherboard offers several additional advantages over the other systems. The NVDIA ION chipset contains 16 GPU “cores” (really heavily multithreaded AIMD units) on each motherboard. Furthermore, the ION chip also acts as the overall memory controller for the system, with the GPUs and the ATOM processor sharing memory space. This memory sharing feature is significant because since version 2.2 CUDA offers the so called ‘zero-copy’ API whereby instead of copying the data to be used by the GPU, the code can just pass pointers for a substantial increase in speed.

The projected aggregate parameters of the system will be the following:

100 CPU cores+800 NVIDIA GPU cores.

200 GB total memory.

˜70 TB total disk space.

20 GBytes/s aggregate sequential IO.

1,800 W of power consumption.

$54K total cost for the systems, excluding the network switches.

### 3. Data and Storage Layout

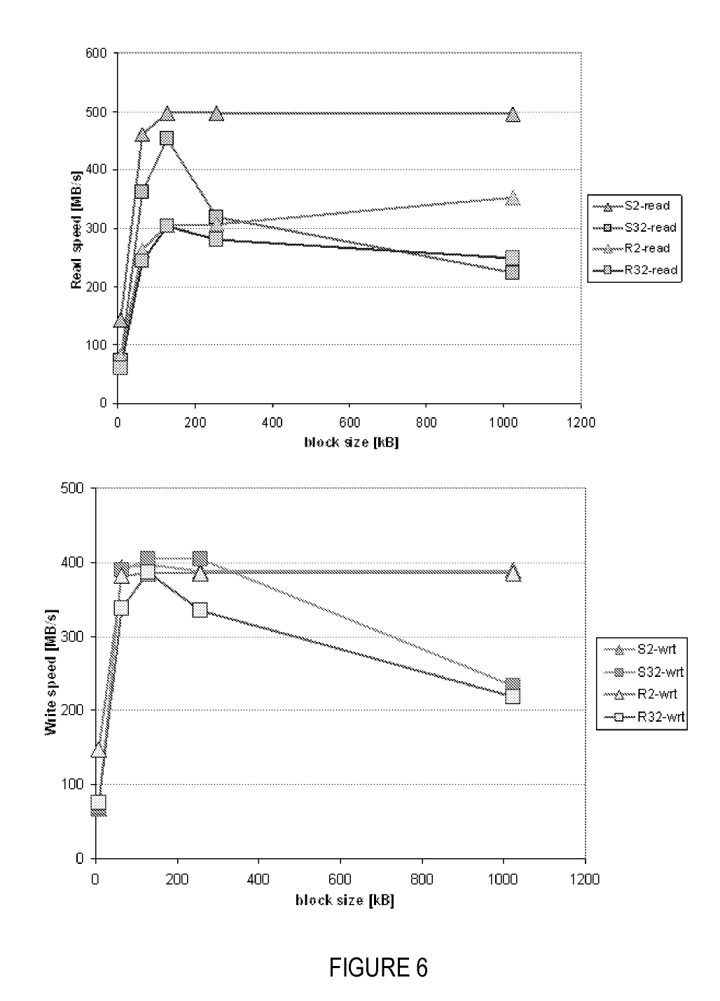

This example focuses on maximizing the aggregate sequential IO performance of the whole system. True to the scale-down spirit, the basic building blocks will consist of a single low power Mini-ITX motherboard with 2-3 disk drives. Table 2 presented the summary of measurements on the various motherboards. In this section some of the detailed results of the low level IO testing are shown. FIG. 6 shows the read and write performance of the Zotac motherboard with two OCZ Vertex SSDs, using both sequential and random access patterns, on 2 and 32 threads. The charts show that with two OCZ Vertex drives, a 500 MB/s sequential read performance is achieved. The results also show that as the number of read threads increases the small cache of the Atom processor has an impact on performance (see peak at 128 kB block size). On the other hand, the write performance is quite respectable at 400 MB/s. Finally, the peak aggregate IOPS performance was close to 20,000 for the two SSDs.

These Phase 1 examples show that using the dual Atom Zotac boards with their three internal SATA channels leads to a solid 500 MB/s sequential read performance using two high-performance SSDs, with write speeds also reaching 400 MB/s. This fact is leveraged in this example, and such systems used as modular building blocks. However, a disadvantage of these systems is that current SSD prices for drives larger than 120 GB are costly, but they are rapidly becoming cheaper.

In order to balance this smaller amount of SSD storage, a similar number of hybrid nodes are used in which one SATA port will still contain an OCZ Vertex drive, while the other two ports will have either a Samsung Spinpoint F1 1 TB 3.5 in drive (at 7.5 W), or a Samsung Spinpoint M1 0.5 TB 2.5 in drive (at 2.5 W). The Samsung Spinpoint drives use very high density platters, and on the F1 drives have 128 MB/s measured for sequential read, rather remarkable for a hard drive, especially that this is delivered at a power consumption of only 7.5 W. While the Samsung drives have slightly lower sequential IO performance compared to the SSDs, they can still almost saturate the motherboard's throughput and at the same time attach a lot more disk space. 3.5 and/or 2.5 in drives can be used.

Eight of these low-power systems will form a larger block, and will be connected to a Gbit Ethernet switch, connected to two more hybrid nodes serving as data aggregators. An even mix of the pure SSD and the hybrid nodes can be used.

### 4. Software Used

The operating system on the cluster will be Windows 7 Release Candidate. The database engine is SQL Server 2008. The installation of these components is fully automated across the cluster. For resource tracking, data partitioning and workflow execution a middleware, originally written for the GrayWulf project may be deployed. Standard utilities may be used to monitor the performance of the system components (SQLIO and PERFMON). The statistical analysis will be done with the Random Forest algorithm, written in C (for CUDA) and in .NET for Windows. A Random Forest implementation in C (for CUDA) that interfaces directly with the database can be used.

### Low Level IO Testing, Monitoring Tools

A combination of Jim Gray's MemSpeed tool, and SQLIO (D. Cherry. Performance Tuning with SQLIO. Available from: http://sqlserverpedia.com/wiki/SAN_Performance_Tuning_with_SQLIO, 2008) can be used for monitoring. MemSpeed measures system memory performance itself, along with basic buffered and unbuffered sequential disk performance. SQLIO can perform various IO performance tests using IO operations whose patterns resemble that of a production SQL Server. Using SQLIO, sequential reads and writes, and random IOPS can be tested, although sequential read performance may be of greater concern.

Performance measurements presented here are typically based on SQLIO's sequential read test, using 128 KB requests, one thread per system processor, and 32-deep requests per thread. This may most resemble the typical table scan behavior of SQL Server. IO speeds measured by SQLIO are very good predictors for SQL Server's real-world IO performance.

The full-scale GrayWulf system is rather complex, with many components performing tasks in parallel. A detailed performance monitoring subsystem can track and quantitatively measure the behavior of the hardware. Specifically, the performance data can be monitored in several different contexts:
Track and monitor the status of computer and network hardware in the “traditional” sense.
Monitor the level of parallelism as a tool to help design and tune individual SQL queries.
Track the status of long-running queries, particularly those that are heavy consumers of CPU, disk, or network resources in one or more of the GrayWulf machines

The performance data are acquired both from the well-known “PerfMon” (Windows Performance Data Helper) counters and from selected SQL Server Dynamic Management Views (DMVs). To understand the resource utilization of different long-running queries, it is useful to be able to relate DMV performance observations of SQL Server objects such as filegroups with PerfMon observations of per-processor CPU utilization and logical disk IO.

Performance data for SQL queries are gathered by a C# program that monitors SQL Trace events and samples performance counters on one or more SQL Servers. Data are aggregated in a SQL database, where performance data is associated with individual SQL queries. This part of the monitoring represented a particular challenge in a parallel environment, since there is no easy mechanism to follow process identifiers for remote subqueries. Data gathering is limited to “interesting” SQL queries, which are annotated by specially-formatted SQL comments whose contents are also recorded in the database.

### Overall Performance

The system having low power motherboards can deliver in real-life scenarios an order of magnitude higher IO performance per watt than traditional systems. By combining SSDs and regular disks, the system retains a high IO rate while still maintaining a large storage capacity.

System and/or Application

Low power systems can be used to build “blades” with an Amdahl number close to unity, whether using SSDs or regular hard disks. By scaling down and out, rather than up, the system has a much better balance throughout the whole IO architecture than traditional systems. The low power cluster is also much more cost effective per unit sequential IO than traditional systems.

### Scalability

By building a cluster of 50 nodes, the design is scalable to at least one hundred nodes.

### Storage Resource Utilization

Using a pragmatic mixture of solid state and conventional (but very low power) hard disks can unify the benefits of both systems, that is the high sequential IO performance of the SSDs and the large storage capacity of conventional hard dives.

### Innovation

By building a custom application that uses low power CPUs for the IO intensive tasks but performs the more floating-point intensive statistical computations on integrated GPUs, the system has unique features. In particular, the system can use integrated memory and zero copy options offered by the NVIDIA ION chip. CUDA tasks callable from SQL functions can also be integrated.

### Effectiveness

Several new, emerging hardware trends (low power CPUs, SSDs, GPUs) are combined into a unique data-intensive computational platform.

The nature of scientific computing is changing—it is becoming more and more data-centric while at the same time datasets continue to double every year, surpassing petabyte scales. As a result, the computer architectures currently used in scientific applications are becoming increasingly energy inefficient as they try to maintain sequential I/O performance with growing dataset sizes.

The scientific community therefore faces the following dilemma: find a low-power alternative to existing systems or stop growing computations on par with the size of the data. Thus, a solution is to build scaled-down and scaled-out systems comprising large numbers of compute nodes each with much lower relative power consumption at a given sequential I/O throughput.

In this example, Amdahl's laws guide the selection of the minimum CPU throughput necessary to run data-intensive workloads dominated by sequential I/O. Furthermore, a new class of so-called Amdahl blades combines energy-efficient processors and solid state disks to offer significantly higher throughput and lower energy consumption. Dual-core Amdahl blades represent a sweet spot in the energy-performance curve, while alternatives using lower power CPUs (i.e., single-core Atom, Geode) and Compact Flash cards offer lower relative throughput.

An advantage of existing systems is their higher total storage space. However, as SSD capacities are undergoing an unprecedented growth, this temporary advantage will rapidly disappear: as soon as a 750 GB SSD for $400 is available, the storage built of low-power systems will have a lower total cost of ownership than regular hard drives.

While offering unprecedented performance, the example architecture also introduces novel challenges in terms of data partitioning, fault tolerance, and massive computation parallelism. Interestingly, some of the approaches, proposed in the context of wireless sensor networks and federated databases, that advocate keeping computations close to the data, can be translated to this new environment.

The current invention is not limited to the specific embodiments of the invention illustrated herein by way of example, but is defined by the claims. One of ordinary skill in the art would recognize that various modifications and alternatives to the examples discussed herein are possible without departing from the scope and general concepts of this invention.

1. A computing device comprising:
a processor operable to process data at a processing speed; and
a storage device in communication with the processor operable to retrieve stored data at a data transfer rate,
wherein the data transfer rate substantially matches the processing speed.

2. The computing device of claim 1, wherein the data transfer rate comprises a peak data transfer rate of the storage device.

3. The computing device of claim 1, wherein the data transfer rate comprises a sequential read throughput of the storage device.

4. The computing device of claim 1, wherein the processing speed comprises a peak processing speed of the processor.

5. The computing device of claim 1, wherein the processing speed comprises a rate the processor processes data.

6. The computing device of claim 1, wherein a ratio of the data transfer rate to the processing speed is between 0.6 and 1.7.

7. The computing device of claim 1, wherein the computing device further comprises memory in communication with the processor and the storage device, operable to store data retrieved from the storage device for processing by the processor.

8. The computing device of claim 1, wherein the memory comprises at least one of:
a primary storage device;
random access memory;
a processor register; or
a cache.

9. The computing device of claim 1, wherein the processor comprises a central processing unit (CPU).

10. The computing device of claim 1, wherein the storage device comprises at least one of:
a secondary storage device;
a mass storage device;
a hard disk drive;
a solid state hard drive;
a flash memory drive;
a magnetic tape drive; or
an optical drive.

11. The computing device of claim 1, wherein processor comprises a plurality of processing units adapted to process the data.

12. The computing device of claim 1, wherein the storage device comprises a plurality of storage units represented as a logical unit.

13. The computing device of claim 12, wherein the plurality of storage units comprise:
a first storage unit comprising a solid state disk (SSD); and
a second storage unit comprising a hard disk drive.

14. The computing device of claim 1, further comprising:
a second processor operable to process data at a second processing speed and in communication with the first processor; and
a second storage device in communication with the second processor operable to retrieve stored data at a second data transfer rate,
wherein the second data transfer rate substantially matches the second processing speed.

15. A computing system comprising:
a first computing device comprising:
a processor operable to process data at a processing speed; and
a storage device in communication with the processor operable to retrieve stored data at a data transfer rate,
wherein the data transfer rate substantially matches the processing speed; and
a second computing device in communication with the first computing device, comprising:
a second processor operable to process data at a second processing speed; and
a second storage device in communication with the second processor operable to retrieve stored data at a second data transfer rate,
wherein the second data transfer rate substantially matches the second processing speed.

16. The computing system of claim 15, wherein the first computing device and second computing device are adapted to process data in parallel.

17. The computing system of claim 15, further comprising a third computing device in communication with the first computing device, comprising:
a third processor operable to process data at a third processing speed; and
a third storage device in communication with the third processor operable to retrieve stored data at a third data transfer rate,
wherein the third data transfer rate substantially matches the third processing speed.

18. The computing system of claim 17, wherein the third computing device is in communication with the second computing device.
